(19) United States
(12) Patent Application Publication
(10) Pub. No.: US 2009/0294357 A1
(43) Pub. Date: Dec. 3, 2009

(54) Method for Concentrating Nanosuspensions

(76) Inventors: Jonathan Graham Peel Binner, Leicestershire (GB); Maria Isabel Santacruz, Leicestershire (GB); Ketharam Annapoorani, Leicestershire (GB)

Correspondence Address: HARRINGTON & SMITH, PC, 4 RESEARCH DRIVE, Suite 202, SHELTON, CT, 06484-6212, US

(21) Appl. No.: 11/922,624

(22) PCT Filed: Jun. 8, 2006
(86) PCT No.: PCT/GB2006/002081

§ 371 Date: Jun. 8, 2009

(30) Foreign Application Priority Data
Jun. 22, 2005 (GB) 0512666.9

(51) Int. Cl. B01D 15/04

(52) U.S. Cl. 210/638; 210/640

(57) ABSTRACT

A method for concentrating a nanosuspension including nanopowder particles suspended in a liquid includes reducing the liquid content of the nanosuspension and controlling the dispersion of the nanopowder particles in the liquid.

The present invention relates to a method for concentrating nanosuspensions, and particularly but not exclusively to a method for concentrating zirconia nanosuspensions. The invention also relates to nanosuspensions.

Nanopowders have a tendency to agglomerate during processing resulting in nanocomponents which may have undesirable material properties.

Wet forming techniques using nanosuspensions, in which nanopowder particles are suspended in a liquid, can be used to alleviate this problem. However, when the nanopowder particles in the suspension approach within approximately 2 nm of each other, the interactions are such that the force required to move them past each other increases significantly, i.e. there is a significant increase in the viscosity of the suspension.

For a given solids content, the finer the. nanopowder particles, the closer they will approach each other. Thus, as particle size decreases, higher viscosities are experienced. Consequently, in order to provide nanosuspensions comprising fine nanopowder particles with an acceptably low viscosity to enable subsequent processing of the nanosuspension to form nanocomponents, it is conventionally necessary to provide a low solids content.

According to a first aspect of the present invention, there is provided a method for concentrating a nanosuspension comprising nanopowder particles suspended in a liquid, the method comprising reducing the liquid content of the nanosuspension and controlling the dispersion of the nanopowder particles in the liquid.

The step of controlling the dispersion of the nanopowder particles in the liquid may comprise modifying the acidity of the nanosuspension, and may comprise modifying the acidity of the nanosuspension prior to the step of reducing the liquid content of the nanosuspension.

The step of modifying the acidity of the nanosuspension may comprise increasing the pH of the nanosuspension above the isoelectric point of the nanopowder particles, and may comprise decreasing the acidity of the nanosuspension. The step of modifying the acidity of the nanosuspension may alternatively comprise decreasing the pH of the nanosuspension to below the isoelectric point of the nanopowder particles, and may comprise increasing the acidity of the nanosuspension.

When the nanosuspension comprises an acidic solution, the step of modifying the acidity of the nanosuspension may comprise increasing the pH of the nanosuspension, for example to provide a basic solution. The nanosuspension may have a pH of between approximately 1.5 and approximately 6.5 prior to the step of modifying the acidity of the nanosuspension, and may have a pH of approximately 2.4 prior to the step of modifying the acidity of the nanosuspension.

The step of modifying the acidity of the nanosuspension may comprise increasing the pH of the nanosuspension to between approximately 9.0 and approximately 12.5. The step of modifying the acidity of the nanosuspension may comprise increasing the pH of the nanosuspension to approximately 11.5.

The step of modifying the acidity of the nanosuspension may comprise decreasing the acidity of the nanosuspension, for example by introducing an alkali into the nanosuspension. The alkali may comprise a dry alkali substance, and may comprise a dry alkali powder. The dry alkali substance may comprise tetramethyl ammonium hydroxide. Alternatively, the alkali may comprise an alkali solution. The alkali solution may comprise ammonium hydroxide solution.

The step of controlling the dispersion of the nanopowder particles in the liquid may comprise generating dispersion of the nanopowder particles in the liquid prior to the step of reducing the liquid content of the nanosuspension. The step of generating dispersion of the nanopowder particles in the liquid may comprise generating electrosteric dispersion, or alternatively generating steric dispersion, or alternatively generating electrostatic dispersion.

The step of generating electrosteric dispersion of the nanopowder particles in the liquid may comprise introducing a polyelectrolyte, such as a surfactant, into the nanosuspension.

The surfactant may be an anionic surfactant, and may comprise ammonium polyacrylate, for example CIBA® DISPEX® A40. The surfactant may alternatively be a cationic surfactant.

The step of reducing the liquid content of the nanosuspension may comprise heating the nanosuspension to evaporate a proportion of the liquid, and may comprise maintaining the nanosuspension at the heated temperature to evaporate a proportion of the liquid.

The step of heating the nanosuspension may be carried out by using a heated water bath or alternatively by using a microwave heating arrangement.

The heating step may comprise heating the nanosuspension to a temperature up to approximately 80° C. The heating step may comprise heating the nanosuspension to a temperature between approximately 45° C. and approximately 60° C. The heating step may be carried out by heating the nanosuspension to a temperature less than 45° C. at a pressure less than ambient.

Alternatively or additionally, the step of reducing the liquid content of the nanosuspension may comprise passing the nanosuspension through filtration means. The step of passing the nanosuspension through the filtration means may comprise forcing the nanosuspension through the filtration means, for example by the application of pressure. The step of passing the nanosuspension through the filtration means may comprise passing the nanosuspension through a filter press arrangement.

The step of controlling the dispersion of the nanopowder particles in the liquid may alternatively or additionally comprise agitating the nanosuspension during the step of reducing the liquid content of the nanosuspension and/or after the step of reducing the liquid content of the nanosuspension. Where the nanosuspension is agitated during the step of reducing the liquid content of the nanosuspension, the heating step may be temporarily suspended during agitation, and may subsequently be resumed.

The step of agitating the nanosuspension may comprise subjecting the nanosuspension to ultrasound to vibrate the nanosuspension.

The nanosuspension may be subjected to ultrasound at discrete intervals having a predetermined duration. The method may comprise increasing the predetermined duration of the discrete intervals, for example as the liquid content of the nanosuspension decreases. The method may comprise decreasing the duration between the discrete intervals to thereby increase the frequency of the discrete intervals, for example as the liquid content of the nanosuspension decreases.

The method may comprise increasing the vibration frequency and/or power of the ultrasound preferably as the liquid content of the nanosuspension decreases.

The nanopowder particles may comprise zirconia nanopowder particles, and may comprise yttria-doped zirconia nanopowder particles. The liquid may be a water-based liquid.

The unconcentrated nanosuspension may comprise less than 30 wt % nanopowder particles, and may have a viscosity of less than 0.1 Pa-s at a shear rate of 100 s⁻¹.

The method may provide a concentrated nanosuspension comprising between the weight percentage content of nanopowder particles of the unconcentrated suspension and approximately 80 wt % nanopowder particles, and the nanosuspension may have a viscosity of less than 2 Pa-s at a shear rate of 100 s⁻¹.

The nanosuspension may comprise between approximately 50 wt % and approximately 80 wt % nanopowder particles.

The method may provide a concentrated nanosuspension having a viscosity of less than 1 Pa-s at a shear rate of 100 s⁻¹, and may provide a concentrated nanosuspension having a viscosity of approximately 0.5 Pa-s at a shear rate of 100 s⁻¹.

The method may provide a concentrated nanosuspension comprising between approximately 50 wt % and approximately 80 wt % nanopowder particles. The method may provide a concentrated nanosuspension comprising approximately 56 wt % nanopowder particles or comprising approximately 70 wt % nanopowder particles.

According to a second aspect of the present invention, there is provided a nanosuspension comprising nanopowder particles suspended in a liquid, wherein the nanosuspension has been concentrated using the method according to the first aspect of the present invention.

After concentration, the nanosuspension may comprise between the weight percentage content of nanopowder particles of the unconcentrated suspension and approximately 80 wt % nanopowder particles, and may have a viscosity of less than 2 Pa-s at a shear rate of 100 s⁻¹.

According to a third aspect of the present invention, there is provided a nanosuspension comprising between approximately 50 wt % and approximately 80 wt % nanopowder particles suspended in a liquid, the nanosuspension having a viscosity of less than 2 Pa-s at a shear rate of 100 s⁻.

The nanosuspension may have a viscosity of less than 1 Pa-s at a shear rate of 100 s⁻¹, and may have a viscosity of approximately 0.5 Pa-s at a shear rate of 100 s⁻¹.

The nanosuspension may comprise between approximately 55 wt % and approximately 70 wt % nanopowder particles.

The nanopowder particles may have an average diameter of less than 100 nm, and may have an average diameter of approximately 20 nm.

The nanopowder particles may comprise zirconia nanopowder particles, and may comprise yttria-doped zirconia nanopowder particles.

The liquid may be a water-based liquid.

Embodiments of the present invention will now be described for the purposes of illustration only.

The invention provides generally a method for concentrating nanosuspensions comprising nanopowder particles suspended in a liquid, for example a water-based liquid. Whilst not limited to any particular nanosuspension, in one embodiment the method is used for concentrating zirconia nanosuspensions in which zirconia nanopowder particles are suspended in a liquid.

Depending upon the desired material properties of the nanocomponents to be produced using the zirconia nanosuspension, the nanosuspension may comprise pure zirconia nanopowder particles, or may alternatively comprise yttria-doped nanopowder particles. For example, zirconia nanosuspensions comprising 1.5, 2.7, 3, 5, 8 or 10 mol % yttria, available from MEL Chemicals, could be concentrated using the method according to the invention.

In general, the method is used to concentrate nanosuspensions having a low solids content, for example less than 30 wt % nanopowder particles, and having an initial viscosity, prior to concentration, of less than 0.1 Pa-s at a shear rate of 100 s⁻¹.

The approximate average diameter of the nanopowder particles in typical nanosuspensions which can be concentrated using the method is in the order of 20 nm.

The nanosuspension is concentrated using the method according to the invention by reducing the liquid content of the nanosuspension and controlling the dispersion of the nanopowder particles in the liquid.

As a first step, and depending upon the acidity of the unconcentrated nanosuspension, the step of controlling the dispersion of the nanopowder particles in the liquid may comprise initially modifying the acidity of the nanosuspension to a desired pH level. In particular, when the nanosuspension is an acidic solution, the pH of the nanosuspension is increased above the isoelectric point of the nanopowder particles to provide a basic solution. In a preferred embodiment, the unconcentrated nanosuspension has a pH of approximately 2.4, and the step of modifying the acidity comprises increasing the pH to approximately 11.5.

The pH of the nanosuspension is increased by introducing an alkali into the nanosuspension and, in order to avoid diluting the nanosuspension and reducing its concentration, the use of a dry alkali substance is advantageous. In particular, a dry alkali powder such as tetramethyl ammonium hydroxide may be added to the unconcentrated nanosuspension to increase the pH.

In an alternative embodiment, an alkali solution, such as ammonium hydroxide solution, may be added to the nanosuspension to increase the pH. However, the use of a solution has the disadvantage of increasing the liquid content of the nanosuspension, thereby diluting the nanosuspension.

Once the acidity of the nanosuspension has been modified to provide a basic solution, the. step of controlling the dispersion of the nanopowder particles in the liquid comprises generating electrosteric dispersion of the nanopowder particles in the liquid. In a preferred embodiment of the invention, electrosteric dispersion is generated by introducing a surfactant into the nanosuspension.

When the nanosuspension is a basic solution, for example having a pH of approximately 11.5, an anionic surfactant is introduced into the nanosuspension to generate electrosteric dispersion. It has been found that an anionic surfactant such as ammonium polyacrylate, for example CIBA® DISPEX® A40 produced by Ciba Speciality Chemicals, is suitable for generating the required electrosteric dispersion.

After the dispersion of the nanopowder particles in the liquid has been controlled using the above steps, the liquid content of the nanosuspension is reduced to concentrate the nanosuspension.

In one embodiment of the invention, the liquid content is reduced by heating the nanosuspension to evaporate a proportion of the liquid, thereby resulting in an increase in the weight percentage content of nanopowder in the nanosuspension. It has been found that heating the nanosuspension to a temperature between approximately 45° C. and approximately 60° C., and maintaining it at that temperature for a period of approximately three days, provides a controlled evaporation of the liquid and results in an acceptable solids content. However, the nanosuspension may be heated to any temperature up to approximately 80° C., and may be maintained at that temperature for any suitable period of time.

As an alternative to, or in addition to, the above, the liquid content may be reduced by forcing the nanosuspension through a filtration means, for. example by using a suitable filter press arrangement. Any suitable filtration means in which the nanosuspension is forced through an ultrafine filtration membrane could be used for this purpose.

The step of controlling the dispersion of the nanopowder particles in the liquid may further or alternatively comprise agitating the nanosuspension during and/or after the step of reducing the liquid content of the nanosuspension by heating and/or filtration. This enables the viscosity of the nanosuspension to be maintained at an acceptable level, as the liquid content decreases, by maintaining the separation of the nanopowder particles.

The nanosuspension is agitated by subjecting it to ultrasound to thereby vibrate the nanosuspension. In order to reduce the temperature of the nanosuspension whilst ultrasound is being applied, and thereby minimise evaporation of the liquid from the nanosuspension, it is advantageous to cool the nanosuspension in a cold water bath whilst it is being subjected to ultrasound.

In one embodiment of the invention, the nanosuspension is subjected to a single application of ultrasound after the step of reducing the liquid content of the nanosuspension by heating has been completed.

In an alternative embodiment of the invention, the nanosuspension is subjected to ultrasound at discrete intervals during the heating and/or filtration step. These discrete intervals are of a predetermined duration and may be applied at times predetermined according to the solids content or the viscosity of the nanosuspension. For example, in the former case, the nanosuspension could be subjected to ultrasound when it comprises 38, 48, 54 and 56 wt % nanopowder particles. In the latter case, it could be subjected to ultrasound when the viscosity is greater than or equal to 1 Pa-s at a shear rate of 100 s⁻¹.

As the liquid content of the nanosuspension decreases, and hence the viscosity of the nanosuspension increases, it may be desirable to subject the nanosuspension to ultrasound for periods of increasing duration, and/or to decrease the duration between the discrete intervals at which ultrasound is applied thereby increasing the frequency of the intervals. By way of example only, the initial duration of the discrete intervals during which the nanosuspension is subjected to ultrasound may be in the order of two minutes.

In a further embodiment, the nanosuspension could be subjected to ultrasound continuously throughout the heating and/or filtration step to maintain the viscosity of the nanosuspension at an acceptable level.

The nanosuspension may be subjected to ultrasound having a suitable power, frequency and amplitude. Ultrasound having a power of 75 W, vibration frequencies of 20 and 24 kHz, and an amplitude of 14 μm has been found to be suitable. It is also possible that the power and/or frequency and/or amplitude of the ultrasound could be increased as the solids content, and hence viscosity, of the nanosuspension increases.

Using the method described above, it is possible to produce nanosuspensions having high solids content and low viscosity. In particular, the method may be used to provide a concentrated nanosuspension comprising between the weight percentage content of nanopowder particles of the unconcentrated suspension and 80 wt % nanopowder particles, the nanosuspension having a viscosity of less than 2 Pa-s at a shear rate of 100 s⁻¹.

The applicant has appreciated that in some circumstances, if the solids content of the nanosuspension is too high, it can become unstable and can be prone to a sudden increase in viscosity if left standing for any. period of time. Concentrated nanosuspensions comprising approximately 56 wt % nanopowder particles having a viscosity of approximately 0.5 Pa-s at a shear rate of 100 s⁻¹ have been produced using the method described above and have been found to be stable.

There is thus provided a method for concentrating a nanosuspension which is capable of producing a nanosuspension having a high solids content and a low viscosity.

Providing a concentrated nanosuspension having a high solids content, and thus low liquid content, and having a relatively low viscosity is advantageous since the concentrated nanosuspension can be more easily processed to produce nanocomponents having desirable material properties. Furthermore, the cost of transporting such concentrated nanosuspensions is less than the cost of transporting conventional nanosuspensions which, in order to achieve an acceptable viscosity, comprise a significant amount of liquid.

The step of controlling the dispersion of the nanopowder particles in the liquid by generating electrosteric dispersion has been found to be advantageous since it ensures that the nanopowder particles are adequately dispersed in the liquid before the amount of liquid is reduced during the heating and/or filtration step.

If the unconcentrated nanosuspension is an acidic solution and an anionic surfactant is to be used to generate electrosteric dispersion, it is particularly important that the pH of the nanosuspension is increased to provide a basic solution prior to addition of the surfactant since otherwise the desired electrosteric dispersion may not be generated.

The step of controlling the dispersion of the nanopowder particles in the liquid to maintain the dispersion of the nanopowder particles by subjecting the nanosuspension to ultrasound during and/or after the heating and/or filtration step is also advantageous since it enables the viscosity of the nanosuspension to be carefully controlled and maintained at an acceptable level.

Although embodiments of the invention have been described in the preceding paragraphs with reference to various examples, it should be appreciated that various modifications to the examples given may be made without departing from the scope of the present invention, as claimed.

For example, if the unconcentrated nanosuspension is a basic solution, it is not necessary to modify the acidity of the nanosuspension prior to adding an anionic surfactant.

It is also possible that electrosteric dispersion could be generated in an acidic solution by introducing a cationic surfactant into the nanosuspension. In this case, it would not be necessary to modify the acidity of the nanosuspension prior to introducing the cationic surfactant

The step of generating dispersion of the nanopowder particles in the liquid may comprise generating steric dispersion or electrostatic dispersion instead of electrosteric dispersion.

Whilst endeavouring in the foregoing specification to draw attention to those features of the invention believed to be of particular importance, it should be understood that the Applicant claims protection in respect of any patentable feature or combination of features hereinbefore referred to and/or shown in the drawings, whether or not particular emphasis has been placed thereon.

1. A method for concentrating a nanosuspension comprising nanopowder particles suspended in a liquid, the method comprising the steps of:
(i) introducing a surfactant into the unconcentrated nanosuspension to increase dispersion of the nanopowder particles in the liquid and thereby create a dispersed unconcentrated nanosuspension;
(ii) reducing the liquid content of the dispersed unconcentrated nanosuspension to increase the concentration of the nanosuspension; and
(iii) subjecting the nanosuspension to ultrasonic agitation at a plurality of discrete intervals during step (ii) to control the dispersion of the nanopowder particles in the liquid.

2. A method according to claim 1, wherein the method comprises modifying the acidity of the nanosuspension prior to introducing the surfactant in step (i).

3. A method according to claim 2, wherein the step of modifying the acidity of the nanosuspension comprises increasing the pH of the nanosuspension above the isoelectric point of the nanopowder particles.

4. A method according to claim 2, wherein, when the nanosuspension comprises an acidic solution, the step of modifying the acidity of the nanosuspension comprises increasing the pH of the nanosuspension to provide a basic solution.

5. A method according to claim 2, wherein the nanosuspension has a pH of between approximately 1.5 and approximately 6.5 prior to the step of modifying the acidity of the nanosuspension.

6. A method according to claim 5, wherein the nanosuspension has a pH of approximately 2.4 prior to the step of modifying the acidity of the nanosuspension.

7. A method according to claim 2, wherein the step of modifying the acidity of the nanosuspension comprises increasing the pH of the nanosuspension to between approximately 9.0 and approximately 12.5.

8. A method according to claim 7, wherein the step of modifying the acidity of the nanosuspension comprises increasing the pH of the nanosuspension to approximately 11.5.

9. A method according to claim 2, wherein the step of modifying the acidity of the nanosuspension comprises introducing an alkali into the nanosuspension to decrease the acidity thereof.

10. A method according to claim 9, wherein the alkali comprises a dry alkali substance.

11. A method according to claim 10, wherein the dry alkali substance comprises a dry alkali powder.

12. A method according to claim 10, wherein the dry alkali substance comprises tetramethyl ammonium hydroxide.

13. A method according to claim 9, wherein the alkali comprises an alkali solution.

14. A method according to claim 13, wherein the alkali solution comprises ammonium hydroxide solution.

15. A method according to claim 1, wherein step (i) generates electrosteric dispersion of the nanopowder particles in the liquid.

16. A method according to claim 1, wherein the surfactant is an anionic surfactant.

17. A method according to claim 1, wherein the surfactant comprises ammonium polyacrylate.

18. A method according to claim 1, wherein step (ii) comprises heating the nanosuspension to evaporate a proportion of the liquid.

19. A method according to claim 18, wherein the heating step comprises heating the nanosuspension to a temperature up to approximately 80° C.

20. A method according to claim 19, wherein the heating step comprises heating the nanosuspension to a temperature between approximately 45° C. and approximately 60° C.

21. A method according to claim 18, wherein the nanosuspension is maintained at the heated temperature to evaporate a proportion of the liquid.

22. A method according to claim 1, wherein step (ii) comprises passing the nanosuspension through filtration means.

23. A method according to claim 1, wherein the method further comprises subjecting the nanosuspension to ultrasonic agitation after step (ii).

24. A method according to claim 1, wherein the discrete intervals have a predetermined duration.

25. A method according to claim 24, wherein step (iii) comprises increasing the predetermined duration of the discrete intervals as the liquid content of the nanosuspension decreases during step (ii).

26. A method according to claim 24, wherein step (iii) comprises decreasing the duration between the discrete intervals to increase the frequency of the intervals as the liquid content of the nanosuspension decreases during step (ii).

27. A method according to claim 1, wherein the method comprises increasing the vibration frequency and/or power of the ultrasound as the liquid content of the nanosuspension decreases.

28. A method according to claim 1, wherein the nanopowder particles comprise zirconia nanopowder particles.

29. A method according to claim 28, wherein the nanopowder particles comprise yttria-doped zirconia nanopowder particles.

30. A method according to claim 1, wherein the liquid is a water-based liquid.

31. A method according to claim 1, wherein the unconcentrated nanosuspension comprises less than 30 wt % nanopowder particles, and has a viscosity of less than 0.1 Pa-s at a shear rate of 100 s⁻¹.

32. A method according to claim 31, wherein the method provides a concentrated nanosuspension comprising between the weight percentage content of nanopowder particles of the unconcentrated suspension and approximately 80 wt % nanopowder particles, the concentrated nanosuspension having a viscosity of less than 2 Pa-s at a shear rate of 100 s⁻¹.

33. A method according to claim 32, wherein the method provides a concentrated nanosuspension comprising between approximately 50 wt % and approximately 80 wt % nanopowder particles.

34. A method according to claim 32, wherein the method provides a concentrated nanosuspension having a viscosity of less than 1 Pa-s at a shear rate of 100 s⁻¹.

35. A method according to claim 34, wherein the method provides a concentrated nanosuspension having a viscosity of approximately 0.5 Pa-s at a shear rate of 100 s⁻¹.
